(19) United States
(12) Patent Application Publication
(10) Pub. No.: US 2014/0356820 A1
(43) Pub. Date: Dec. 4, 2014

(54) LANGUAGE TEACHING MATERIAL CUSTOMIZING SYSTEM, LANGUAGE TEACHING MATERIAL CUSTOMIZING METHOD AND RECORDING MEDIUM

(71) Applicant: Shunji Hayashi, Tokyo (JP)

(72) Inventor: Shunji Hayashi, Tokyo (JP)

(73) Assignee: BIGLOBE Inc., Tokyo (JP)

(21) Appl. No.: 14/365,031

(22) PCT Filed: Dec. 13, 2012
(86) PCT No.: PCT/JP2012/082422

§ 371 Date: Jun. 12, 2014

(30) Foreign Application Priority Data
Dec. 13, 2011 (JP) 2011-272137

(51) Int. Cl. G09B 5/04; G09B 19/06

(52) U.S. Cl. CPC G09B 5/04; G09B 19/06
USPC 434/157

(57) ABSTRACT

A language teaching material customizing system is provided in which a user can customize a language teaching material content freely. Specifically, the language teaching material customizing system of the present invention includes a client apparatus which produces customization data and a server apparatus which produces language teaching material content data. The server apparatus includes a storage section which stores an original sentence text, a translation sentence text, an original sentence sound source, a translation sentence sound source and a segment sound, and a control section which produces the language teaching material content data based on the customization data. The client apparatus includes a display section which displays a customization screen, an input section which receives an input from the user, and a control section which produces the customization data based on the input of the user.

### TECHNICAL FIELD

The present invention relates to a language teaching material customizing system, and especially, a language teaching material customizing system which can customize language teaching material content data according to a desire of a user.

### BACKGROUND ART

In the language learning, there is a method of learning basic syntax and words by hearing short sentences. Language teaching material contents used in this method have been provided as audio books such as a CD book. The language teaching material content data which is contained in the audio book is predetermined in a sequence of short sentences, and a sequence of original sentences and translation sentences, so that a pattern of sound sources is not changeable. Thus, the sequence cannot be changed.

Japanese Patent publication (JP 2008-32788A (Patent Literature 1) discloses a technique of a language teaching material producing program which generates language teaching material data from text data. In this reference, first, text data is divided into sentences. Next, the speech synthesis processing of the text data is carried out in units of sentences, to generate sentence voice data. Next, a sentence and sentence data (sentence segment data) are added to the header section of the sentence voice data to generate sentence voice teaching material data. Lastly, the sentence voice teaching material data are combined so as to generate the language teaching material data.

### CITATION LIST

[Patent literature 1] JP 2008-32788A

### SUMMARY OF THE INVENTION

An object of the present invention is to provide a language teaching material customizing system in which a user can customize language teaching material contents freely.

The language teaching material customizing system of the present invention includes: a storage section configured to store an original sentence voice data file and a translation sentence voice data file; an input section configured to input a reproduction sequence of the original sentence voice data file and the translation sentence voice data file; and a control section configured to produce customization data which contains an original sentence voice data file identifier for identifying the original sentence voice data file and a translation sentence voice data file identifier for identifying the translation sentence voice data file and a sequence pattern showing the reproduction sequence.

A language teaching material customizing method of the present invention is a method executed by the language teaching material customizing system. The language teaching material customizing method includes inputting a reproduction sequence of an original sentence voice data file and a translation sentence voice data file by an input section, and producing customization data which contains an original sentence voice data file identifier for identifying the original sentence voice data file and a translation sentence voice data file identifier for identifying the translation sentence voice data file and a sequence pattern showing the reproduction sequence, by a control section of a client apparatus.

A software program of the present invention is a program to make a computer execute processing of the language teaching material customizing method. Note that the program according to the present invention can be stored in a storage unit and a storage medium.

According to the present invention, the language teaching material customizing system can be provided in which the user can customize the language teaching material contents freely.

### BRIEF DESCRIPTION OF THE DRAWINGS

FIG. 1 is a block diagram a language teaching material customizing system according to the present invention.

FIG. 2 is an example of the sentences management DB 30 according to the present invention.

FIG. 3 is an example of an original sentence voice data management DB 40 according to the present invention.

FIG. 4 is an example of a translation sentence voice data management DB 50 according to the present invention.

FIG. 5 is an example of a user management DB 70 according to the present invention.

FIG. 6A is a first part of a flow chart of a language teaching material customizing method by a language teaching material customizing system.

FIG. 6B is a second part of the flow chart of a language teaching material customizing method by a language teaching material customizing system.

FIG. 7 is an example of a content list screen in the language teaching material customizing system according to the present invention.

FIG. 8 is an example of a sample selection screen of a sequence pattern in the language teaching material customizing system according to the present invention.

FIG. 9 is an example of an edition screen in the sequence pattern in the language teaching material customizing system according to the present invention.

FIG. 10 is an example of a selection screen of a sentence in the language teaching material customizing system according to the present invention.

FIG. 11 is an example of a customization data generation execution screen in the language teaching material customizing system according to the present invention.

FIG. 12 is an example of a sequence pattern in the language teaching material customizing system according to the present invention.

FIG. 13 is an example of a download execution screen in the language teaching material customizing system according to the present invention.

### DESCRIPTION OF EXEMPLARY EMBODIMENTS

### Exemplary Embodiments

Hereinafter, exemplary embodiments of the present invention will be described in detail with reference to the attached drawings.

### (Language Teaching Material Customizing System)

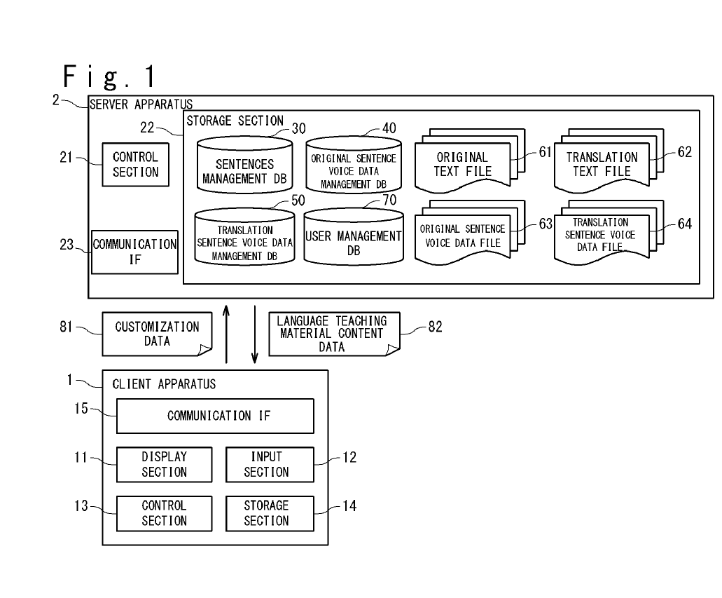

With reference to FIG. 1, a configuration example of a language teaching material customizing system according to the present invention will be described.

The language teaching material customizing system according to the present invention includes a client apparatus 1 and a server apparatus 2.

As an example of the client apparatus 1 and the server apparatus 2, computers such as a PC (personal computer), an appliance, a workstation, a mainframe, and a supercomputer are exemplified. Besides, as an example of the client apparatus 1, a portable phone, a smart phone, a smart book, an IP telephone, a car navigation system, a carrying-type game machine, a home-use game machine, a carrying-type music player, a handy terminal, a gadget (electronic equipment), an interactive TV, a digital tuner, a digital recorder, information home appliance, OA (Office Automation) equipment, a storefront terminal, a high function copy machine, a digital signage (electronic signboard) and so on are exemplified. The client apparatus 1 and the server apparatus 2 may be installed in movement bodies such as a vehicle, a ship, and an aircraft. It should be noted that the client apparatus 1 and the server apparatus 2 may be relay equipment and a peripheral device in addition to a terminal and a server. Also, the client apparatus 1 and the server apparatus 2 may be an expansion board which is installed in the computer and a virtual machine (VM) which is built on a physical machine. However, actually, the present invention is not limited to these examples.

It should be noted that in FIG. 1, only the client apparatus 1 is shown for simplification of the explanation, but a plurality of client apparatuses may exist. In the same way, a plurality of server apparatuses may exist for the reasons such as load distribution. For example, it is possible to adopt a multitier architecture, a cluster system, a fault tolerant system or a cloud computer and so on, in the language teaching material customizing system according to the present invention. However, actually, the present invention is not limited to these examples.

The client apparatus 1 includes a display section 11, an input section 12, a control section 13, a storage section 14 and a communication IF (interface) 15.

The display section 11 displays data necessary to customize language teaching material content data on a screen by a Web browser. In the present exemplary embodiment, customization data is displayed on the screen by using the Web browser of the client apparatus 1. As an example of the display section 11, display units such as LCD (liquid crystal display) and PDP (plasma display monitor), organic EL display (organic electroluminescence display) are exemplified. Or, the display section 11 may be an interface (IF) to output data to an external display unit and storage unit. That is, the display section 11 may be an output unit. However, actually, the present invention is not limited to these examples.

The language teaching material content data according to the present invention is sound source data produced by sequentially arranging sound sources such as an original sentence voice data file, a translation sentence voice data file, and a Beep sound for the numbers determined according to the desire of a user based on the customization data. The language teaching material content data according to the present invention is reproduced by the client apparatus and a sound source reproducing apparatus for sound source data transferred from the client apparatus. Note that the text data of a sentence may be involved in the language teaching material content data so that the text data is displayed at the time of reproduction of the sound source data.

The input section 12 is an input interface (IF) of a keyboard or a mouse which is used for the user to customize the language teaching material content data. Note that the input section 12 may be of a touch panel type, using the display section 11. As an example of the input section 12, KVM (keyboard video mouse), a console, a keypad, a touch panel, and an input device of a tablet, or a read unit for various types of information transfer media are exemplified. Or, the input section 12 may be an interface (IF) to acquire data from an input unit and a storage unit. However, actually, the present invention is not limited to these examples.

The control section 13 generates customization data 81 based on an input from the input section 12. The detail of the customization data 81 will be described later. As an example of the control section 13, a CPU (Central Processing Unit), a network processor (NP), a microprocessor, a microcontroller and a semiconductor integrated circuit (LSI: Large Scale Integration) which has a function of exclusive use are exemplified. However, actually, the present invention is not limited to these examples.

The storage section 14 stores the language teaching material content data 82 generated based on the customization data 81. A semiconductor memory device such as RAM (Random Access Memory), ROM (Read Only Memory), EEPROM (Electrically Erasable and Programmable Read Only Memory) and a flash memory, an auxiliary storage unit such as HDD (Hard Disk Drive) and SSD (Solid State Drive), a removable disk such as DVD (Digital Versatile Disk), and storage media such as an SD memory card (Secure Digital memory card) are exemplified as an example of the storage section 14. Also, it may be a buffer, a register and so on. Or, a storage apparatus which uses DAS (Direct Attached Storage), FC-SAN (Fibre Channel-Storage Area Network), NAS (Network Attached Storage), IP-SAN (IP-Storage Area Network), and so on may be used. However, actually, the present invention is not limited to these examples.

The communication IF 15 is an interface (IF) for the client apparatus 1 and the server apparatus 2 to communicate through a network. As an example of the communication IF 15, a substrate (motherboard, I/O board) corresponding to the network communication, a semiconductor integrated circuit such as a chip, a network adapter such as NIC (Network Interface Card) and a similar extension card, a communication device such as an antenna, a communication port such as a connection mouth (connector) and so on are exemplified. Also, as an example of the network, the Internet, LAN (Local Area Network), wireless LAN (Wireless LAN), WAN (Wide Area Network), backbone, a CATV line, a fixation type telephone network, a mobile phone network, WiMAX (IEEE 802.16a), 3G (3^{rd} Generation), a dedicated line (lease line), IrDA (Infrared Data Association), Bluetooth (registered trademark), a serial communication line, a data bus and so on are exemplified. However, actually, the present invention is not limited to these examples.

The server apparatus 2 includes a control section 21, a storage section 22 and a communication IF 23.

The control section 21 generates language teaching material content data 82 customized based on the customization data 81 which are generated by the client apparatus 1. An example of the control section 21 is the same as the above-mentioned control section 13.

The storage section 22 stores a sentences management DB 30, an original sentence voice data management DB 40, a translation sentence voice data management DB 50, a user management DB 70, an original text file 61, a translation text file 62, an original sentence voice data file 63 and a translation sentence voice data file 64. The example of the storage section 22 is the same as the above-mentioned storage section 14.

The communication IF 23 is an interface for the server apparatus 2 and the client apparatus 1 to communicate through the network. The example of the communication IF 23 is the same as the above-mentioned communication IF 15.

### (Sentences Management DB)

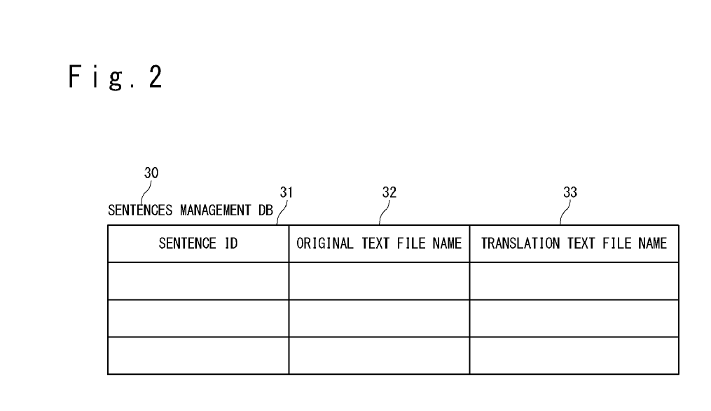

With reference to FIG. 2, a configuration example of the sentences management DB 30 according to the present invention will be described.

A record of the sentences management DB 30 contains a sentence ID (identifier) 31, an original text file name 32, and a translation text file name 33.

The sentence ID 31 is an identifier to identify text data of sentences stored in the server apparatus 2 (original text file 61 and translation text file 62) and voice data (original sentence voice data file 63 and translation sentence voice data file 64) in order to use for the language teaching material content data 82. Note that the voice data is identified by using a talker ID (identifier).

The original text file name 32 is a file name of the original text file 61.

The translation text file name 33 is a file name of the translation text file 62.

Note that there is a case that the text data is identified based on the plurality of IDs (identifiers). For example, it is such a case that translation sentences in a plurality of languages (Japanese, Korean, and Chinese) should be prepared from an English original sentence. In such a case, a translation country ID is provides and the translation sentence is identified based on the sentence ID 31 and the translation country ID. In the same way, by providing another ID to the voice data, the voice data can be identified based on the plurality of IDs. For example, the voice data is identified based on the sentence ID, the talker ID, and the translation country ID.

Note that in the sentences management DB 30 according to the present invention, the original text data and the translation text data are managed by managing the original text file name 32 and the translation text file name 33 for every sentence ID 31. However, in place of the above method of managing the file names, the original text data and the translation text data may be directly managed by the sentences management DB 30.

### (Original Sentence Voice Data Management DB)

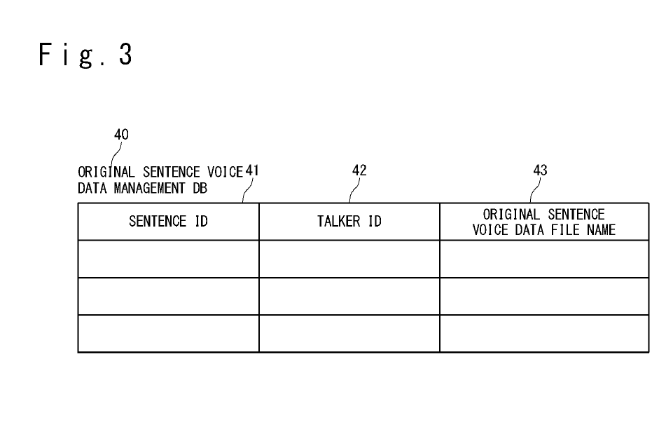

With reference to FIG. 3, a configuration example of the original sentence voice data management DB 40 according to the present invention will be described.

One record of the original sentence voice data management DB 40 contains a sentence ID 41, a talker ID 42 and an original sentence voice data file name 43.

The sentence ID 41 is an identifier to identify the text data of the sentence (the original text file 61 and the translation text file 62) and the voice data (the original sentence voice data file 63 and the translation sentence voice data file 64) which are stored in the server apparatus 2 in order to use for the language teaching material content data 82.

The talker ID 42 is an identifier to identify a talker (a person) uttering the original sentence voice data. That is, the talker ID 42 can say to be an identifier to identify the voice of the talker. Therefore, the talker ID 42 can be replaced by a voice ID (identifier). Note that actually, the original sentence voice data may be synthesized voice data. In this case, the talker is a speech synthesizer, a text-to-speech system and so on.

In the original sentence voice data management DB 40, there is a case that the original sentence voice data file, which is different in the talker, is prepared in the server apparatus 2, even if the original sentence voice data 63 of the identical sentence exists. In this case, the original sentence voice data file 63 is identified based on the sentence ID 41 and the talker ID 42. At this time, the original sentence voice data file 63 may be individually prepared according to each of the attributes of the talker. For example, the original sentence voice data file 63 (for every attribute) different in the talker is prepared, depending on the difference in the sexuality of the talker, the difference in the language area such as American English, British English, and Australian English in case of the English original sentence voice data, the difference in the age of the talker such as an adult and a child, and the difference in the voice data quality, the tone, and the acting of the talker. Note that the identical talker may be allocated with another talker ID 42 for every kind of the voice (handling as the separate talkers) when the voices of the plurality of kinds can be uttered. Thus, the language teaching material content data 82 which is adapted for the desire of the user can be provided.

The original sentence voice data file name 43 is a file name of the original sentence voice data file 63.

### (Translation Sentence Voice Data Management DB)

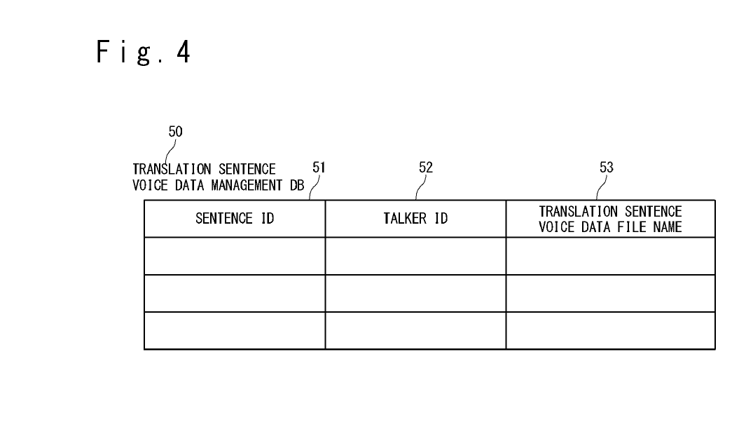

With reference to FIG. 4, a configuration example of the translation sentence voice data management DB 50 according to the present invention will be described.

A record of the translation sentence voice data management DB 50 contains the sentence ID 51, the talker ID 52 and the translation sentence voice data file name 53.

The sentence ID 51 is an identifier to identify the text data (the original text file 61 and the translation text file 62) and the voice data (the original sentence voice data file 63 and the translation voice data file 64) of the sentence which are stored in the server apparatus 2, in order to use for the language teaching material content data 82.

The talker ID 52 is an identifier to identify the talker (the person) who utters the translation sentence voice data. That is, the talker ID 52 can be said to be an identifier to identify the voice of the talker. Therefore, the talker ID 52 can be replaced by a voice ID (identifier). Note that actually, the translation sentence voice data may be synthesized voice data. In this case, the talker is a speech synthesizer, a text-to-speech system and so on.

In the translation sentence voice data management DB 50, there is a case that the translation voice data file different in the talker even in case of the translation sentence voice data to the identical sentence is prepared in the server apparatus 2. In this case, the translation sentence voice data file 64 is identified based on the sentence ID 51 and the talker ID 52. At this time, the translation voice data file 64 may be individually prepared for every attribute of the talker. For example, the translation sentence voice data files 64 by different talkers (for every attribute) are prepared, depending on the difference in the sexuality of the talker, the difference in the language area such as America English, British English, and Australian English in case of the English translation sentence voice data, the difference in the age of the talkers such as the adult and the child, and the difference in the voice data quality, the tone, and the acting of the talker. Note that when an identical talker can utter a plurality kinds of voices, another talker ID 52 may make be allocated for every kind of voice (handled as the separate talkers). Thus, the language teaching material content data 82 which is adapted for the desire of the user can be provided.

The translation voice data file name 53 is a file name of the translation voice data file 64.

### (Remarks)

Note that in this exemplary embodiment, the original sentence voice data is managed in the original sentence voice data management DB 40 and the translation sentence voice data is managed in the translation sentence voice data management DB 50. However, both of them may be managed as voice data without dividing into two DBs. In this case, a data kind identifier is prepared to indicate that the voice data file is for which of the original sentence and the translation sentence, and the voice data is identified based on the sentence ID, the talker ID, and the data kind identifier.

Also, when the voice data and the text data are managed integratedly in the original sentence voice data management DB 40 and the translation sentence voice data management DB 50, a kind of data may be identified in such a manner as 0: original sentence text file, 1: translation sentence text file, 2: original sentence voice data file, 3: translation sentence voice data file.

As mentioned above, a method of identifying the original sentence voice data file and the translation sentence voice data file is not unique and may be selected appropriately by a skilled person. For example, the original sentence voice data file may be identified based on the sentence ID+the talker ID as an original sentence voice data file identifier, and the translation sentence voice data file may be identified based on the sentence ID+data type identifier as a translation sentence voice data file identifier.

### (User Management DB)

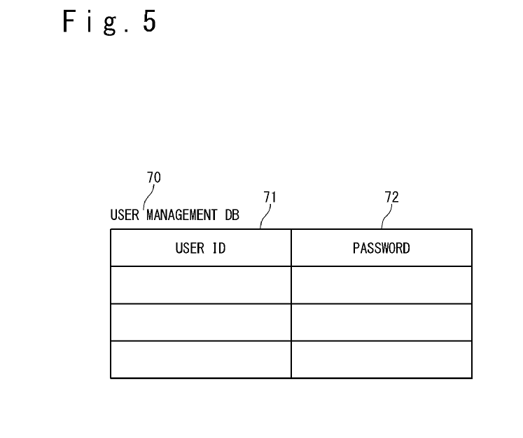

With reference to FIG. 5, a configuration example of the user management DB 70 according to the present invention will be described.

A record of the user management DB 70 contains a user ID 71 and a password 72.

The user ID 71 is an identifier for identifying a user of the language teaching material customizing system.

The password 72 is a password corresponding to the user ID 71.

### (Language Teaching Material Customizing Method)

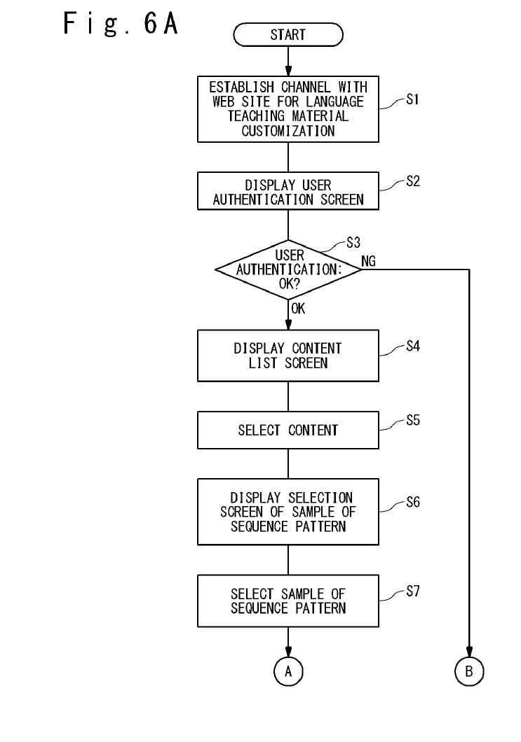

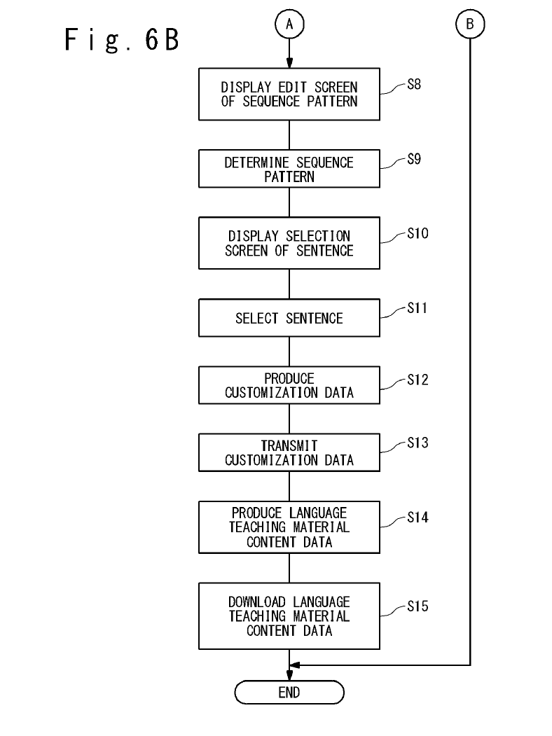

Referring to a flow chart of FIG. 6A and FIG. 6B, a language teaching material customizing method by the language teaching material customizing system according to the present invention will be described.

### (1) Step S1

In response to an input to the input section 12 of the client apparatus 1, the control section 13 starts a Web browser and connects with a Web site for the language teaching material customization.

### (2) Step S2

The control section 21 of the server apparatus 2 transmits data through the communication IF 23 to the client apparatus 1 to display a user authentication screen. The control section 13 of the client apparatus 1 produces a user authentication screen based on the data. The control section 13 of the client apparatus 1 displays the user authentication screen on the display section 11.

### (3) Step S3

The control section 21 of the server apparatus 2 compares a user ID and a password which are transmitted from the client apparatus 1 with data of the user management DB 70. The control section 21 advances to the processing at step S4 if the user authentication is OK. The control section 21 transmits the data to the client apparatus 1 such that an error screen and a screen which prompts for the re-entry of the user ID and the password are displayed, if the user authentication is NG. The control section 13 of the client apparatus 1 controls the display section to display an error screen, and the screen which prompts the re-entry of the user ID and the password is displayed on the display section 11 if the user authentication is NG. Then, the processing ends.

### (4) Step S4

The control section 21 of the server apparatus 2 transmits data through the communication IF 23 to the client apparatus 1 such that a content list screen is displayed on the display section 11 of the client apparatus 1.

### (Content List Screen)

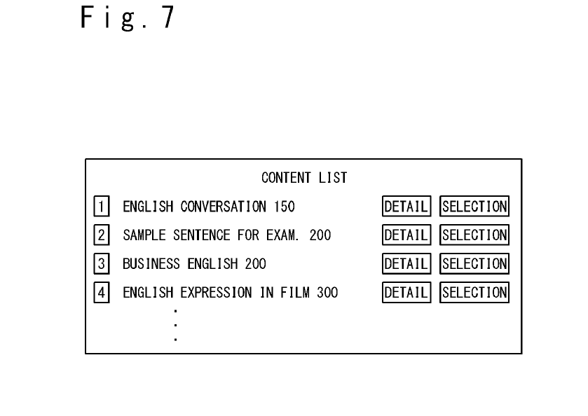

With reference to FIG. 7, a configuration example of the content list screen in the language teaching material customizing system according to the present invention will be described.

The user selects contents for a material of the language teaching material content data 82 from the content list screen as shown in FIG. 7.

Note that in an example of FIG. 7, a detail button is shown for every content. By such a detail button, the display screen is changed to a screen to display the detailed data of each of the contents and the data necessary for the user to select the content may be displayed. Regarding the display of the detail data, an explanation of the content, data of selectable talkers and an example of the selectable sentences and so on are exemplified.

### (5) Step S5

The input section 12 of the client apparatus 1 selects the content from the content list screen.

### (6) Step S6

The control section 21 of the server apparatus 2 receives a notice of the content selected at step S5 from the client apparatus 1 through the communication IF 23. The control section 21 transmits to the client apparatus 1, data for displaying a sample selection screen of a sequence pattern. The control section 13 of the client apparatus 1 displays the sample selection screen of the sequence pattern on the display section 11.

### (Sample Selection Screen of Sequence Pattern)

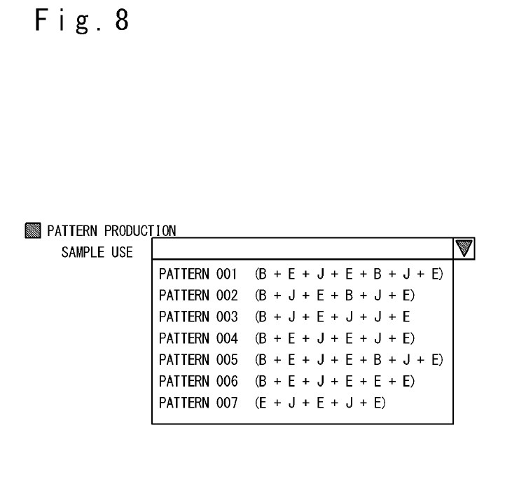

With reference to FIG. 8, a configuration example of the sample selection screen of the sequence pattern in the language teaching material customizing system according to the present invention will be described.

FIG. 8 shows an example when the original sentence is in English, and the sequence pattern can be selected by use of a drop down list.

Here, a sample of the sequence pattern will be described. An example will be described in which the sequence pattern is pattern 004 (B+English+Japanese+English+Japanese+English), the original sentence is “When is your birthday?” and the translation sentence is “Anata no tanzyoubi ha itu?” (in Japanese).

In this case, a sound source is reproduced in the sequence of “Beep sound” (a segment sound source) • “When is your birthday ?” • “Anata no tanzyoubi ha itu?” • “When is your birthday ?” • “Anata no tanzyoubi ha itu?” • “When is your birthday ?”. As for the following sentence, the sound sources are reproduced in the similar sequence pattern (B+English+Japanese+English+Japanese+English).

### (7) Step S7

The input section 12 of the client apparatus 1 selects a sample of the sequence pattern from the sample selection screen of the sequence pattern.

### (8) Step S8

The control section 13 of the client apparatus 1 displays an edition screen of the sequence pattern on the display section 11.

### (Edition Screen of Sequence Pattern)

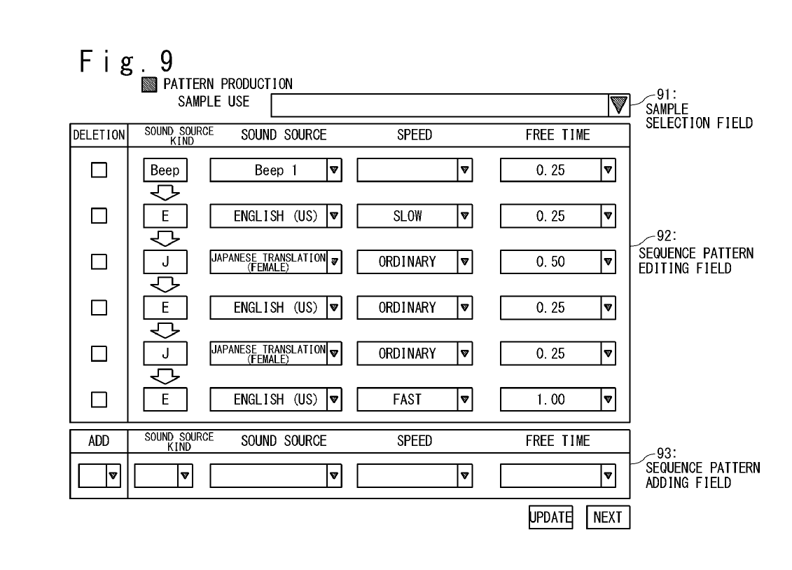

With reference to FIG. 9, a configuration example of the edition screen of the sequence pattern in the language teaching material customizing system according to the present invention will be described.

In an example of FIG. 9, the sequence pattern edition screen is shown when the pattern 004 (B+English+Japanese+English+Japanese+English) is selected in the sample selection screen of FIG. 8.

In the example of FIG. 9, the sample selection field 91 is a display field in the form of a drop down list and the sample selection screen of FIG. 8 is displayed when the drop down list is displayed. The sequence pattern set with predetermined default values is displayed in a sequence pattern edition field 92 based on the pattern selected in sample selection field 91.

In an example of FIG. 9, the sequence pattern that the default values have been set for the sound source, the speed, and the free time is displayed by using the pattern 004. The user can edit the sequence pattern by using the drop down list, according to need, from the state of the sequence pattern which is displayed in the sequence pattern edition field 92.

For example, it is assumed that the sound sources available in the content are English (America), English (United Kingdom), and English (Australia). At this time, the user can select from the drop down list freely. The data displayed in the drop down list of the sound sources is identified based on the talker ID 42 of the original sentence voice data management DB 40 when the sound source kind is an original sentence, and it is identified based on the talker ID 52 of the translation sentence voice data management DB 50 when the sound source kind is a translation sentence. Note that the sound source may be prepared according to a combination of sexuality of the talker such as an America man, in addition to a difference in the linguistic area.

Note that the sequence pattern may be directly produced by using the sequence pattern edition field 92 in a blank in which any default value is not set, by using the sample selection field 91, without selecting a pattern.

In an example of FIG. 9, checkboxes for deletion are displayed in the left end of the sequence pattern edition field 92. When the user has a row to be deleted in case of editing of the sequence pattern, an unnecessary row can be deleted by checking the checkbox of the row and pushing an update button.

Moreover, a sequence pattern addition field 93 is used when a row should be added to the sequence pattern which is displayed in the sequence pattern edition field 92. After determining the sound source kind, a sound source, a speed and a free time, the user selects a row by selecting a row No. of the row from the drop down list which is displayed in the left end of the sequence pattern addition field 93 and pushes the update button. Thus, the row is added.

### (9) Step S9

When the update button is pushed through the input section 12 of the client apparatus 1, the addition or deletion of the row is reflected in the sequence pattern which is displayed in the sequence pattern edition field 92. Note that a pattern registration button may be prepared in the sequence pattern edition screen of FIG. 9 in consideration of the convenience of the user, and by pushing the pattern registration button, the sequence pattern produced by the user may be registered on a drop down list of the sample selection field 91. Moreover, when a next button is pushed through the input section 12 of the client apparatus 1, the control advances to the selection screen of the sentence.

### (10) Step S10

The control section 13 of the client apparatus 1 displays the sentence selection screen on the display section 11.

### (Sentence Selection Screen)

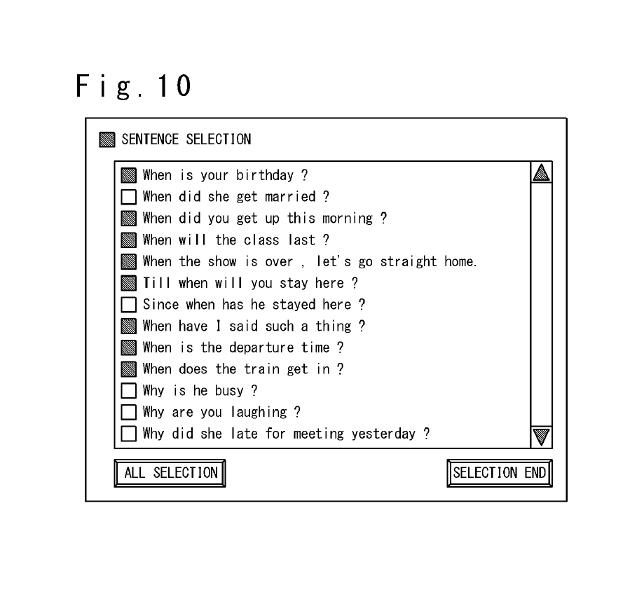

With reference to FIG. 10, a configuration example of the sentence selection screen in the language teaching material customizing system according to the present invention will be described.

### (11) Step S11

A sentence used for the language teaching material content data is selected through the input section 12 of the client apparatus 1. When a selection end button of FIG. 10 is pushed through the input section 12 of the client apparatus 1, the control advances to a customization data production execution screen.

### (12) Step S12

The control section 13 of the client apparatus 1 displays the customization data production execution screen on the display section 11.

### (Customization Data Production Execution Screen)

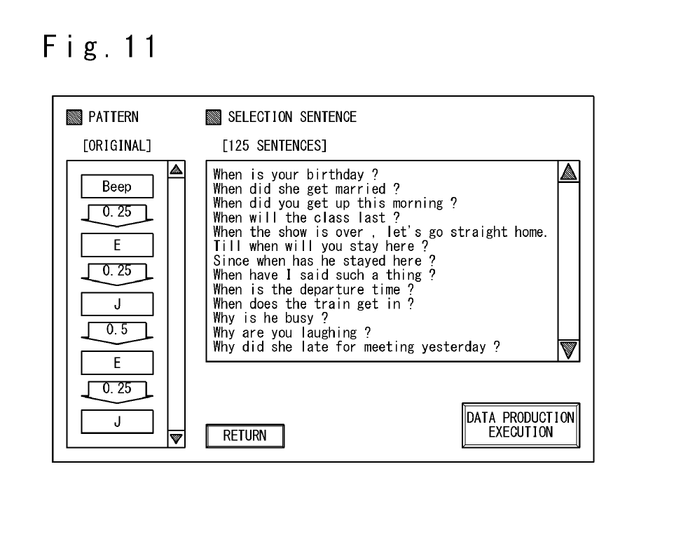

With reference to FIG. 11, a configuration example of the customization data production execution screen in the language teaching material customizing system according to the present invention will be described.

The user can confirm the sequence pattern and the selected sentence finally in the customization data production execution screen.

### (13) Step S13

When the data production execution button is pushed through the input section 12 of the client apparatus 1, the control section 13 transmits the customization data to the server apparatus 2 through the communication IF 15.

The sentence ID used to identify the sentence used for the language teaching material content data 82 and the sequence pattern are contained in the customization data. The sequence pattern contains the sequence data in which the sound source kind of at least one of the voice data of the original sentence, the translation sentence voice data, and the Beep sound (segment sound source) is arranged for a specific number in a reproduction sequence, and the parameter data which is composed of a difference of the sound source specified to each sound source kind (e.g. a talker ID indicating a difference of the talker in case of the voice data, and a kind of sound in case of the Beep sound), the sound source speed, and the sound source output interval. Here, depending on the sound source kind, it may not be specified as the parameter data. For example, it is a sound source speed to the Beep sound, and the difference of the sound source to the voice data of the translation sentence (it is possible to select only the voice data of a woman).

### (Sequence Pattern)

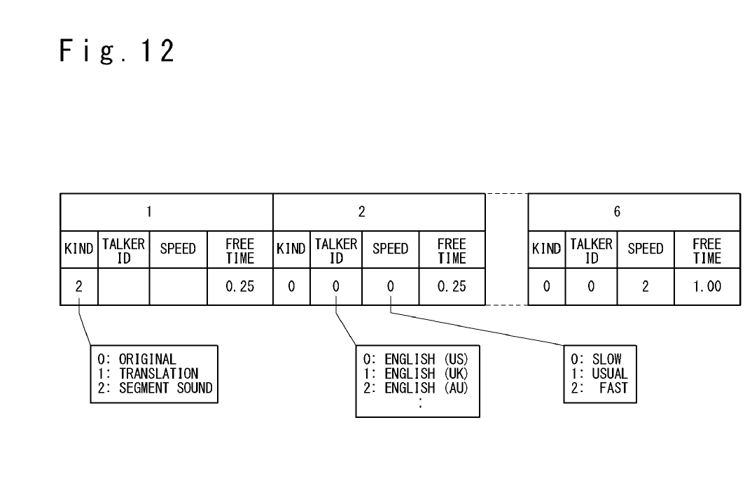

With reference to FIG. 12, a configuration example of the sequence pattern in the language teaching material customizing system according to the present invention will be described.

An example of FIG. 12 is a sequence pattern to notify the values determined in the edition screen of the sequence pattern of FIG. 9 to the server apparatus 2 based on the pattern 004 (B+English (E)+Japanese (J)+English+Japanese+English).

### (14) Step S14

The control section 21 of the server apparatus 2 acquires the customization data 81 from the client apparatus 1 through the communication IF 23. The control section 21 produces the language teaching material content data 82 based on the customization data 81. When specifying a sound source file to be used, first, the control section 21 refers to the sentence ID, the kind and the talker ID, which are contained in the customization data 81. Next, the control section 21 specifies the original sentence voice data file name 43 based on the talker ID 42 and the sentence ID 41 of the original sentence voice data management DB 40 when the kind is the original sentence. The control section 21 specifies a translation sentence voice data file name 53 based on the talker ID 52 and the sentence ID 51 of the translation sentence voice data management DB 50 when the kind is a the translation sentence.

Next, the control section 21 of the server apparatus 2 configures the language teaching material content data 82 so that the specified sound source file and the Beep sound source are reproduced according to the sequence pattern of the customization data 81.

Next, the control section 21 of the server apparatus 2 determines the reproduction speed of the sound source based on the source speed specified by the customization data 81 to each sound source.

Next, the control section 21 of the server apparatus 2 inserts no sound (or, a sound source for a previously determined interval) between the sound sources based on the source output interval specified based on the customization data 81 to each sound source.

Next, the control section 21 of the server apparatus 2 produces a file of language teaching material content data 82, and stores in correspondence to the user ID 71 in the storage section 22 of the server apparatus 2.

### (15) Step S15

The control section 13 of the client apparatus 1 displays a download execution screen on the display section 11 to download the language teaching material content data 82.

### (Download Execution Screen)

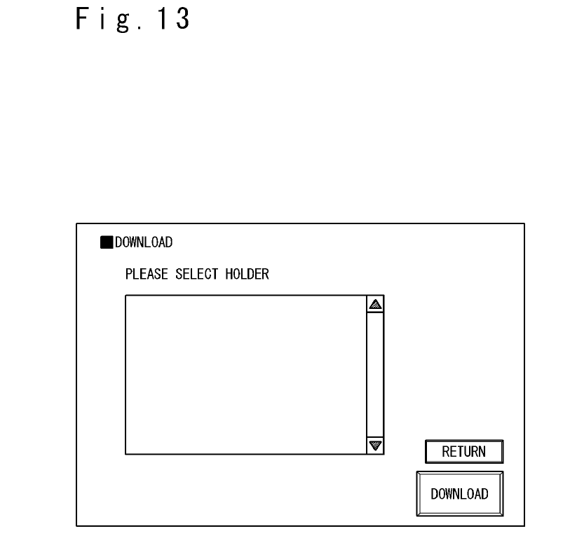

With reference to FIG. 13, a configuration example of the download execution screen in the language teaching material customizing system according to the present invention will be described.

When a download button is pushed through the input section 12 of the client apparatus 1, the download of the language teaching material content data 82 produced by the control section 21 of the server apparatus 2 is executed.

Note that the customization data 81 is produced in the client apparatus 1 in the exemplary embodiment and lastly, the customization data 81 is transmitted to the server apparatus 2 by communicating with the server apparatus 2. Without not adopting such a communication method, the following method may be adopted in which the data of the input and selection by the user is transmitted to the server apparatus for every input and selection by the user of the client apparatus 1 and the control section 21 of the server apparatus 2 produces the customization data 81 in the interactive communication form so as to acquire an answer from the server apparatus 2.

Also, in the present exemplary embodiment, it is not required to install exclusive use software to generate the customization data 81 and the language teaching material content data 82 by providing the customization screen by using the Web browser of the client apparatus 1. Without adopting the above method, the following method may be adopted in which the text data of a sentence to be customized and various kinds of voice data and screens, and an application program which contains a producing program of the customization data 81 are downloaded in the client apparatus 1 and the customization data 81 are all produced in the client apparatus 1. In this case, the control section 13 of the client apparatus 1 may produce and store the language teaching material content data 82 in the storage section 14, after producing the customization data 81.

Note that the control section 13 of the client apparatus 1 may read the customization data 81 in the reproduction software of the client apparatus 1 without producing the language teaching material content data 82, after producing the customization data 81. In this case, the control section 13 of the client apparatus 1 reads only the files of voice data which are necessary for the reproduction and which have been stored in the storage section 14, based on the customization data 81 at the time of the reproduction, and reproduces in real-time (adjustment of the sound source speed and insertion of no sound, according to necessity).

Also, files of the text data and voice data of the sentences are stored in the storage section 22 of the server apparatus, and an application containing the producing program of the customization data 81 and so on is downloaded in the client apparatus 1. After producing in the customization data 81 in the client apparatus 1, the customization data 81 is read in the reproduction software of the client apparatus 1 without producing the language teaching material content data 82.

The control section 13 of the client apparatus 1 acquires files of the voice data which are necessary for the reproduction from the server apparatus 2 in real-time based on the customization data 81, and reproduces (by adjusting the sound source speed and inserting the no sound according to necessity). If necessary, after carrying out the adjustment of the sound source speed, no-sound insertion and so on based on the acquired file, the language teaching material content data 82 is produced and reproduced.

The language teaching material customizing system according to the present invention provides the language teaching material content data 82 that having high language learning effect to fit to the user, because the user can customize the language teaching material content data 82 freely by selecting the sentence and devising an sequence pattern.

### <Supplemental Notes>

A part or all of the above-mentioned exemplary embodiments can be mentioned as the following supplemental notes. However, actually, the present invention is not limited to the following specified examples.

### <Supplemental Note 1>

A language teaching material customizing system includes:

a storage section configured to store original sentence voice data file and translation sentence voice data file;

an input section configured to input a reproduction sequence of the original sentence voice data file and the translation sentence voice data file; and

a control section configured to produce customization data which contains an original sentence voice data file identifier for identifying the original sentence voice data file and a translation sentence voice data file identifier for identifying the translation sentence voice data file and a sequence pattern showing the reproduction sequence.

### <Supplemental Note 2>

The language teaching material customizing system includes according to supplemental note 1, includes:

a client apparatus which includes:
the input section; and
the control section which produces the customization data,

a server apparatus which is connected with the client apparatus and includes:
the storage section; and
a second control section configured to generates language teaching material content data in which the original sentence voice data file and the translation sentence voice data file are stored in a sequence of the sequence pattern based on the customization data, and transmit the language teaching material content data to the client apparatus.

### <Supplemental Note 3>

The language teaching material customizing system includes according to supplemental note 1, includes:

a client apparatus which includes:
the input section; and
the control section which produces the customization data, and

a server apparatus which is connected with the client apparatus and includes:
the storage section,

wherein the control section further acquires the original sentence voice data file and the translation sentence voice data file from the storage section based on the customization data, and generates the language teaching material content data in which the original sentence voice data file and the translation sentence voice data file in the sequence of the sequence pattern.

### <Supplemental Note 4>

The language teaching material customizing system includes according to supplemental note 2, wherein the input section inputs parameter data, which contains a talker ID, a reproduction speed and a sound source output interval, to the original sentence voice data file and the translation sentence voice data file,

wherein the sequence pattern further contains the parameter data,

wherein the second control section of the server apparatus selects and processes the original sentence voice data file and the translation sentence voice data file based on the sequence pattern which contains the parameter data, to generate the language teaching material content data.

### <Supplemental Note 5>

The language teaching material customizing system includes according to supplemental note 3, wherein the input section further inputs the parameter data which contains the talker ID, the reproduction speed and the sound source output interval, to the original sentence voice data file and the translation sentence voice data file,

wherein the sequence pattern contains the parameter data,

wherein the control section further selects and processes the original sentence voice data file and the translation sentence voice data file based on the sequence pattern which contains the parameter data, to generate the language teaching material content data.

### <Supplemental Note 6>

The language teaching material customizing system includes according to any of supplemental notes 2 to 5, wherein the client apparatus displays a customization screen which contains a selection screen of the content as the material of the language teaching material content data, a sample selection screen of the sequence pattern, an edition screen of the sequence pattern, and a selection screen of the sentence, and

wherein the control section produces the customization data based on the input from the input section to the customization screen.

### <Supplemental Note 7>

The language teaching material customizing system according to supplemental note 6, wherein the selection screen of the content, the sample selection screen, the edition screen of the sequence pattern and the selection screen of the sentence are displayed by a Web browser.

### <Supplemental Note 8>

The language teaching material customizing system according to supplemental note 1, wherein the control section reads the original sentence voice data file the translation sentence voice data file from the storage section based on the customization data to reproduce the read files in real-time.

### REMARKS

The exemplary embodiments of the present invention have been described with reference to the drawings. However, the present invention is not limited to the above-mentioned exemplary embodiments and can be appropriately modified by a skilled person in the art without deviating from the features of the present invention.

Note that the present application claims a priority based on Japan Patent Application No. JP 2011-272137. The disclosure thereof is incorporated herein by reference.

1. A language teaching material customizing system comprising:
a storage section configured to store original sentence voice data and translation sentence voice data corresponding to each of languages for every sentence;
an input section configured to input a reproduction sequence of the original sentence voice data and the translation sentence voice data; and
a control section configured to produce customization data which contains an voice data identifier for identifying the original sentence voice data and the translation sentence voice data and a sequence pattern showing the reproduction sequence, read the original sentence voice data and the translation sentence voice data from said storage section based on the customization data, generate language teaching material content data in which the read data are arranged in the reproduction sequence, and reproduce the read data in the reproduction sequence in real-time based on the language teaching material content data.

2. The language teaching material customizing system according to claim 1, wherein said storage section stores the original sentence voice data and the translation sentence voice data for every talker different in sexuality, a linguistic area, and an age.

3. The language teaching material customizing system according to claim 2, wherein the voice data identifier comprises:
a sentence identifier for identifying the sentence;
a talker identifier for identifying a talker; and
a data type identifier for identifying whether voice data is for the original sentence or for the translation sentence.

4. The language teaching material customizing system according to claim 1, wherein the sequence pattern comprises:
sequence data in which at least one audio source type of the original sentence voice data, the translation sentence voice data and a segment audio source is arranged for a specified number in the reproduction sequence; and
parameter data showing a difference of the audio source which is specified to an audio source type, a reproduction speed and an audio source output interval.

5. The language teaching material customizing system according to claim 1, further comprising a display section showing a customization screen which contains a selection screen for a content as a material of the language teaching material content data, a selection screen for a sample of the sequence pattern, an edition screen for the sequence pattern, and a selection screen for the sentence;
wherein said control section displays the customization screen on said display section and acquires data of the reproduction sequence of the original sentence voice data and the translation sentence voice data which is inputted from said input section for the customization screen.

6. The language teaching material customizing system according to claim 5, wherein said control section displays the sequence pattern set with predetermined default values of a talker, a reproduction speed and an sound source output interval on the edition screen of the sequence pattern for every sound source type based on a pattern selected in the selection screen of a sample of the sequence pattern.

7. The language teaching material customizing system according to claim 5, wherein said control section communicates with said input section and said display section through a network, transmits data of the customization screen to said display section and receives the data inputted from said input section for the customization screen.

8. A language teaching material customizing method comprising:
storing original sentence voice data and translation sentence voice data corresponding to each of languages for every sentence;
inputting a reproduction sequence of the original sentence voice data and the translation sentence voice data;
producing customization data which contains a voice data identifier for identifying the original sentence voice data and the translation sentence voice data and a sequence pattern showing the reproduction sequence;
reading the original sentence voice data and the translation sentence voice data based on the customization data to generate language teaching material content data in which the read data are arranged in the reproduction sequence; and
reproducing the read data in the reproduction sequence in real-time based on the language teaching material content data.

9. The language teaching material customizing method according to claim 8, further comprising:
storing the original sentence voice data and the translation sentence voice data for every talker different in sexuality, a linguistic area, and an age to an identical sentence.

10. The language teaching material customizing method according to claim 9, further comprising:
using as a voice data identifier, a sentence identifier for identifying a sentence, a talker identifier for identifying a talker, and a data type identifier for identifying whether voice data is for an original sentence or a translation sentence.

11. The language teaching material customizing method according to claim 8, further comprising:
using as the sequence pattern, sequence data in which at least one sound source of sound source type of the original sentence voice data, the translation sentence voice data and a segment sound source is arranged for a specified number in the reproduction sequence, and a difference in the sound source specified to the sound source type, a reproduction speed and parameter data showing a sound source output interval.

12. The language teaching material customizing method according to claim 8, further comprising:
displaying a customization screen which contains a selection screen of a content as a material of the language teaching material content data, a selection screen of a sample of the sequence pattern, an edition screen of the sequence pattern, and a selection screen of the sentence; and
acquiring data of the reproduction sequence of the original sentence voice data and the translation sentence voice data which is inputted to the customization screen.

13. The language teaching material customizing method according to claim 12, further comprising:
displaying the sequence pattern set with predetermined default values of a talker, a reproduction speed and a sound source output interval for every sound source type contained in the sequence pattern on the edition screen of the sequence pattern based on a pattern selected in the selection screen of a sample of the sequence pattern.

14. The language teaching material customizing method according to claim 12, further comprising:
transmitting data of the customization screen through a network; and
receiving data inputted for the customization screen.

15. A non-transitory computer-readable recording medium which stores a computer-executable program to make a computer execute the language teaching material customizing method comprising:
storing original sentence voice data and translation sentence voice data corresponding to each of languages for every sentence;
inputting a reproduction sequence of the original sentence voice data and the translation sentence voice data;
producing customization data which contains a voice data identifier for identifying the original sentence voice data and the translation sentence voice data and a sequence pattern showing the reproduction sequence;
reading the original sentence voice data and the translation sentence voice data based on the customization data to generate language teaching material content data in which the read data are arranged in the reproduction sequence; and
reproducing the read data in the reproduction sequence in real-time based on the language teaching material content data.
